(19) United States
(12) Patent Application Publication
(10) Pub. No.: US 2007/0233960 A1
(43) Pub. Date: Oct. 4, 2007

(54) Command processing apparatus and command processing method

(75) Inventor: Masanori Yamato, Tokorozawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/640,926

(22) Filed: Dec. 19, 2006

(30) Foreign Application Priority Data
Mar. 30, 2006 (JP) 2006-094361

(51) Int. Cl. G06F 12/00

(52) U.S. Cl. 711/123

(57) ABSTRACT

According to one embodiment, the present invention comprises a command cache in which a command which is not compressed or encoded is written from the outside, a data cache in which a compressed or encoded command is written, a processor which executes processing based on a command written in the command cache, and decompresses or decodes a command written in the data cache, and a special cache in which a command decompressed or decoded by the processor is written and which subjects the command to processing by the processor.

### CROSS-REFERENCE TO RELATED APPLICATIONS

This application is based upon and claims the benefit of priority from Japanese Patent Application No. 2006-094361, filed Mar. 30, 2006, the entire contents of which are incorporated herein by reference.

### BACKGROUND

1. Field

One embodiment of the invention relates to an improvement in a command processing apparatus and a command processing method which decompress and process a compressed command or decode and process an encoded command.

2. Description of the Related Art

As is well known, in an audio-visual (AV) electronic device as typified by, e.g., a television broadcast receiving device, various kinds of functions demanded by a user are executed by supplying a command or data stored in a memory to a processor constituted of a central processing unit (CPU) or the like.

In this case, since writing and reading speeds in the memory are slower than a processing speed of the processor, the processing speed is lowered when a structure in which the process directly accesses the memory is adopted. Therefore, there is usually employed a cache memory which can rapidly cope with an access request from the processor.

That is, two types of cache, i.e., a command cache and a data cache are prepared. When a predetermined function is requested, a command and data required for processing of the processor are respectively transferred from the memory to the command cache and the data cache. Further, the processor acquires the command from the command cache, and transmits/receives data to/from the data cache, thereby realizing high-speed processing.

Meanwhile, as commands stored in the memory, there are compressed commands or encoded commands. In this case, the processor acquires a compressed or encoded command from the memory through the data cache, and performs decompression processing or decoding processing to restore it to a command which can be executed by the processor as it is.

Furthermore, the restored command which can be executed by the processor as it stands is stored in the command cache through the data cache and the memory, whereby it is subjected to processing by the processor. Therefore, when a compressed or encoded command is stored in the memory, it takes time for this command to be restored to a conformation that it can be executed as it stands and stored in the command cache, thereby obstructing high-speed processing.

Jpn. Pat. Appln. KOKAI Publication No. 2004-185627 discloses a technology as a code compressing method of a program which enables high-speed prototyping of a code compression technology, by which a decompression engine is provided between a main memory and a D-cache/command cache so that a decompressed command is directly written in the command cache.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view of an embodiment according to the present invention illustrating an example of a digital television broadcasting receiving device and a network system mainly constituted of this device;

FIG. 2 is a block diagram illustrating a main signal processing system in the digital television broadcasting receiving device in this embodiment;

FIG. 3 is a block diagram illustrating a specific example of information transmitting means between a processor and a memory section in the digital television broadcasting receiving device in this embodiment;

FIG. 4 is a view illustrating an address map of caches in the digital television broadcasting receiving device in this embodiment;

FIG. 5 is a block diagram illustrating a specific example of a judgment section of the processor in the digital television broadcasting receiving device in this embodiment;

FIG. 6 is a flowchart illustrating a judgment operation of the processor in the digital television broadcasting receiving device in this embodiment;

FIG. 7 is a flowchart illustrating an operation of fetching a command from a special cache by the processor in the digital television broadcasting device in this embodiment; and

FIG. 8 is a view illustrating an example of cache tags when a special cache is newly provided in the digital television broadcasting device in this embodiment.

### DETAILED DESCRIPTION

Various embodiments according to the invention will be described hereinafter with reference to the accompanying drawings. In general, according to one embodiment of the invention, the present invention comprises a command cache in which a command which is not compressed or encoded is written from the outside; a data cache in which a compressed or encoded command is written; a processor which executes processing based on a command written in the command cache, and decompresses or decodes a command written in the data cache; and a special cache in which a command decompressed or decoded by the processor is written and which subjects the command to processing by the processor.

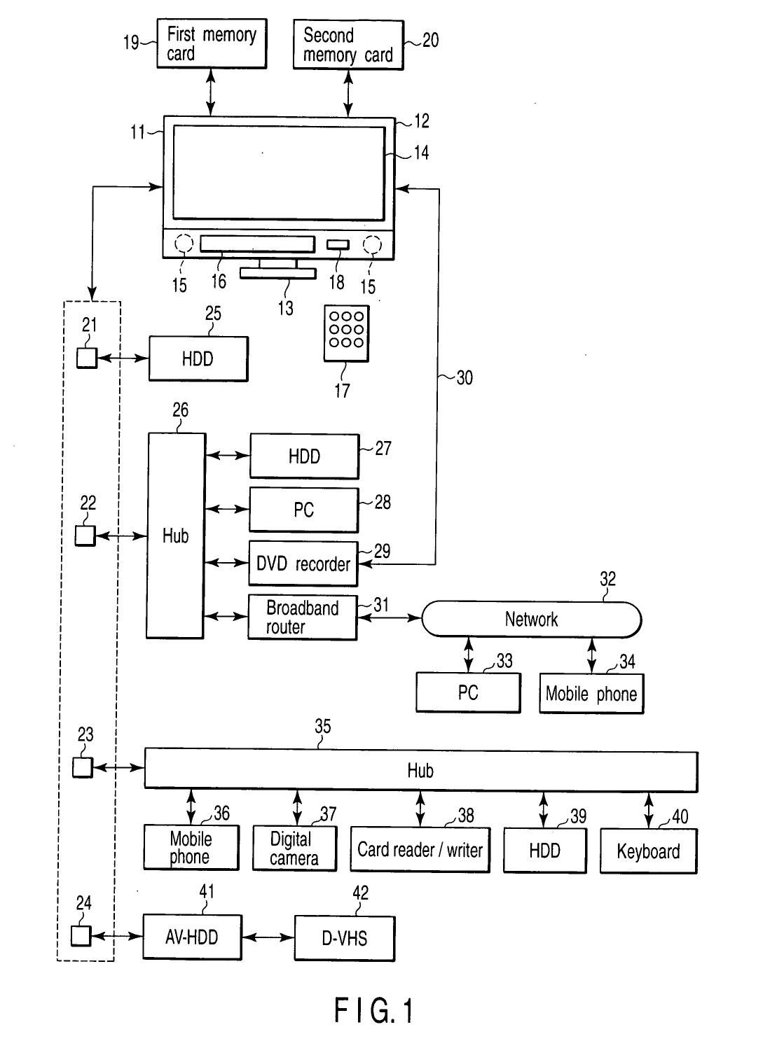

FIG. 1 schematically shows an outer appearance of a digital television broadcasting receiving device explained in this embodiment and an example of a network system mainly constituted of this digital television broadcasting receiving device 11.

That is, the digital television broadcasting receiving device 11 mainly comprises a thin cabinet 12, and a support base 13 which supports this cabinet 12 in an upright posture. Furthermore, in the cabinet 12 are disposed a planar panel type picture display unit 14 consisting of, e.g., a liquid crystal display panel, a speaker 15, an operating section 16, and a photo-receiving section 18 which receives operation information transmitted from a remote controller 17 and others.

Moreover, a first memory card 19 such as an SD (secure digital) memory card or an MMC (multimedia card) is detachable with respect to this digital television broadcasting receiving device 11, and information of, e.g., a program or a photograph can be recorded/reproduced with respect to this first memory card 19.

Additionally, a second memory card [an IC (integrated circuit) card] 20 which includes a semiconductor memory having, e.g., contract information recorded therein is detachable with respect to this digital television broadcasting receiving device, and information can be recorded/reproduced with respect to this second memory card 20.

Further, this digital television broadcasting receiving device 11 is provided with a first local area network (LAN) terminal 21, a second LAN terminal 22, a universal serial bus (USB) terminal 23 and an i. Link terminal 24.

Of these terminals, the first LAN terminal 21 is used as a port dedicated to a hard disk drive (HDD) compatible with a LAN, and utilized to record/reproduce information with respect to an HDD 25 compatible with an LAN which is a connected network attached storage (NAS) based on Ethernet (registered trademark).

When the first LAN terminal 21 as the port dedicated to an HDD compatible with a LAN is provided in this manner, information of a program with high-definition picture quality can be stably recorded with respect to the HDD 25 without being affected by another network environment, a network use situation or the like.

Furthermore, the second LAN terminal 22 is utilized as a general LAN compatible port using Ethernet (registered trademark), and used to connect devices such as an LAN compatible HDD 27, a PC 28, an DVD recorder 29 having a built-in HDD and others through a hub 26 to transmit information with respect to these devices.

It is to be noted that a dedicated analog transmission path 30 must be provided to the DVD recorder 29 in order to transmit analog picture and audio information between the DVD recorder 29 and the digital television broadcast receiving device 11 since digital information transmitted/received through the second LAN terminal 22 is information of a control system alone.

Moreover, this second LAN terminal 22 is connected with a network 32 such as the Internet through a broadband router 31 connected with the hub 26, and used to transmit/receive information to/from a PC 33 or a mobile phone 34 through the network 32.

Additionally, the USB terminal 23 is used as a general USB compatible port, and utilized to connect USB devices such as a mobile phone 36, a digital camera 37, a card reader/writer 38 corresponding to the memory card, an HDD 39, a keyboard 40 and others through a hub 35 in order to transmit/receive information to/from these USB devices.

Further, i. Link terminal 24 is used to connect, e.g., an AV-HDD 41, a digital Video Home System (D-VHS) apparatus 42, a terrestrial digital tuner (not shown) and others in series in order to transmit/receive information to/from these devices.

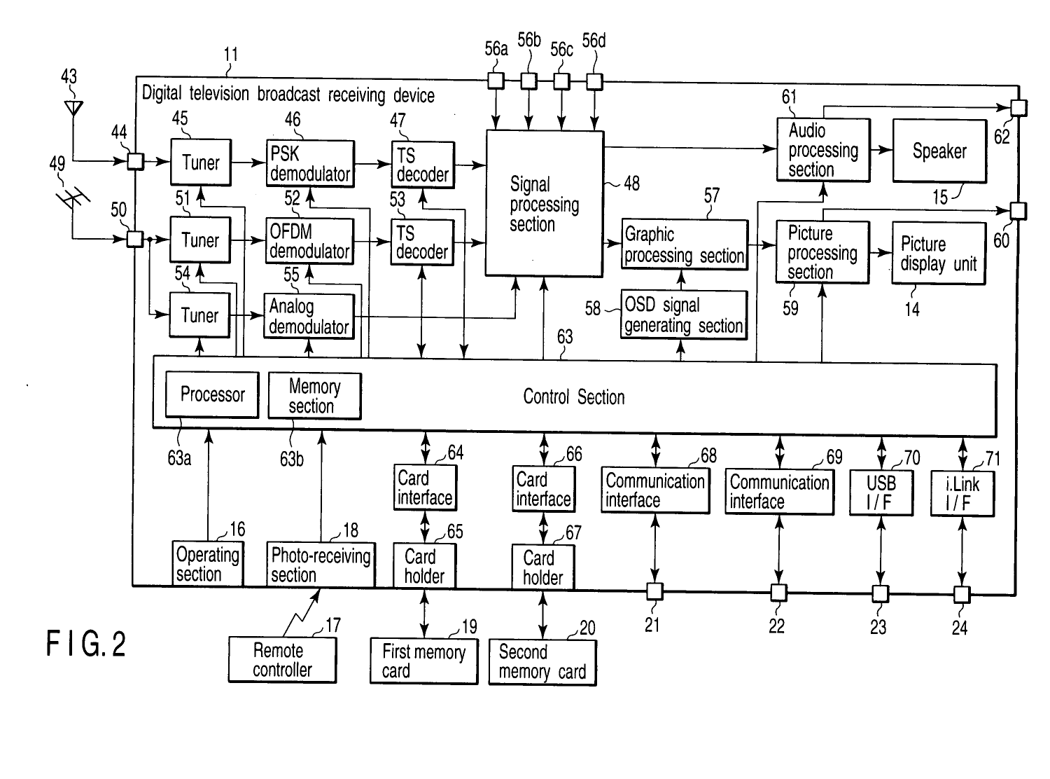

FIG. 2 shows a main signal processing system in the digital television broadcast receiving device 11. That is, a digital direct satellite television broadcast signal received by a BS/CS digital broadcast reception antenna 43 is supplied to a digital direct satellite broadcast tuner 45 via an input terminal 44, thereby selecting a desired channel broadcast signal.

Furthermore, the broadcasting signal selected by this tuner 45 is supplied to a phase shift keying (PSK) demodulator 46 where this signal is demodulated to a digital picture signal and audio signal, and then output to a signal processing section 48 via a transport stream (TS) decoder 47.

Moreover, a terrestrial digital television broadcast signal received by a terrestrial broadcast reception antenna 49 is supplied to a terrestrial digital broadcast tuner 51 via an input terminal 50, thereby selecting a desired channel broadcast signal.

Additionally, the broadcast signal selected by this tuner 51 is supplied to an orthogonal frequency division multiplexing (OFDM) demodulator 52 where this signal is demodulated to a digital picture signal and audio signal, and then output to the signal processing section 48 through a TS decoder 53.

Further, a terrestrial analog television broadcast signal received by the terrestrial broadcast reception antenna 49 is supplied to a terrestrial analog broadcast tuner 54 through an input terminal 50, thereby selecting a desired channel broadcast signal. Furthermore, the broadcast signal selected by this tuner 54 is supplied to an analog demodulator 55 where this signal is demodulated to an analog picture signal and audio signal, and then output to the signal processing section 48.

Moreover, a plurality of (four in the drawing) input terminals 56a, 56b, 56c and 56d are connected with the signal processing section 48. Each of these input terminals 56a to 56d can receive an analog picture signal and an analog audio signal from the outside of the digital television broadcast receiving device 11.

Here, the signal processing section 48 selectively performs predetermined digital signal processing with respect to a digital picture signal and a digital audio signal respectively fed from the TS decoder 47 and 53.

Additionally, this signal processing section 48 selectively digitizes an analog picture signal and an analog audio signal respectively supplied from the analog demodulator 55 and the respective input terminals 56a to 56d, and executes predetermined digital signal processing with respect to the digitized picture signal and audio signal.

As the digital signal processing executed by this signal processing section 48, there are, e.g., MPEG decoding processing with respect to a picture signal, MPEG noise reduction processing which reduces mosquito noise generated with this MPEG decoding processing, processing of superimposing digital graphics data for on-screen display (OSD), which will be referred to as an OSD signal hereinafter, on a picture signal, scaling processing with respect to a picture signal, decoding processing with respect to an audio signal and others.

Further, an OSD signal generated in an OSD signal generating section 58 is superimposed on a digital picture signal output from the signal processing section 48 by a graphic processing section 57, and then the obtained signal is supplied to a picture processing section 59. This picture processing section 59 coverts the input digital picture signal into an analog picture signal having a format which can be displayed in the picture display unit 14, then outputs the converted signal to display its picture in the picture display unit 14, and leads this signal to the outside through an output terminal 60.

Furthermore, the digital audio signal output from the signal processing section 48 is supplied to an audio processing section 61. This audio processing section 61 converts the input digital audio signal into an analog audio signal having a format which can be reproduced by the speaker 15, then outputs the converted signal to the speaker 15 to reproduce its sound, and leads this signal to the outside through an output terminal 62.

Here, all operations including the above-described various kinds of receiving operations of this digital television broadcasting receiving device 11 are integrally controlled by a control section 63. This control section 63 has a built-in processor 63a formed of, e.g., a CPU, receives operation information from the operating section 16 or receives operation information supplied from the remote controller 17 via the photo-receiving section 18, and controls the respective sections to reflect the operation contents.

In this case, the processor 63a utilizes a memory section 63b to perform control. This memory section 63b mainly has a read only memory (ROM) storing a control program executed by the processor 63a, a random access memory (RAM) which provides a working area to the processor 63a, and a non-volatile memory storing various kinds of setting information, control information and others.

Moreover, this control section 63 is connected with a card holder 65 to which the first memory card 19 can be attached via a card interface 64. As a result, the control section 63 can transmit/receive information to/from the first memory card 19 attached to the card holder 65 via the card interface 64.

Additionally, the control section 63 is connected with a card holder 67 to which the second memory card 20 can be attached through a card interface 66. As a result, the control section 63 can transmit/receive information to/from the second memory card 20 attached to the card holder 67 via the card interface 66.

Further, the control section 63 is connected with the first LAN terminal 21 via a communication interface 68. As a result, the control section 63 can transmit/receive information to/from the LAN compatible HDD 25 connected with the first LAN terminal 21 via the communication interface 68. In this case, the control section 63 has a dynamic host configuration protocol (DHCP) server function, and assigns an internet protocol (IP) address to the LAN compatible HDD 25 connected with the first LAN terminal 21 to effect control.

Furthermore, the control section 63 is connected with the second LAN terminal 22 through the communication interface 69. As a result, the control section 63 can transmit/receive information to/from each device (see FIG. 1) connected with the second LAN terminal 22 via the communication interface 69.

Moreover, the control section 63 is connected with the USB terminal 23 through a USB interface 70. As a result, the control section 63 can transmit/receive information to/from each device (see FIG. 1) connected with the USB terminal 23 via the USB interface 70.

Additionally, the control section 63 is connected with the i. Link terminal 24 through an i. Link interface 71. As a result, the control section 63 can transmit/receive information to/from each device (see FIG. 1) connected with the i. Link terminal 24 via the i. Link interface 71.

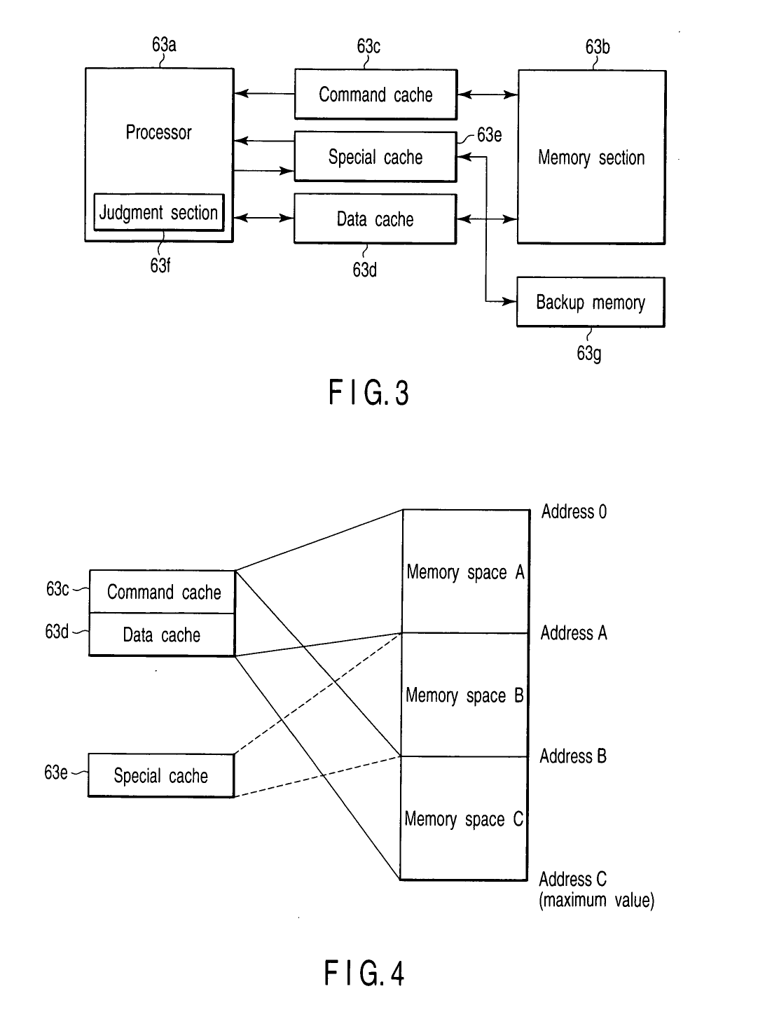

Here, FIG. 3 specifically shows information transmitting means between the processor 63a and the memory section 63b in the control section 63. That is, a command cache 63c and a data cache 63d are respectively interposed between the processor 63a and the memory section 63b.

Further, of commands stored in the memory section 63b, a command which is not compressed or encoded and can be executed by the processor 63a as it stands is written in the command cache 63c and subjected to processing by the processor 63a. Furthermore, data associated with this command is written in the data cache 63b and subjected to processing by the processor 63a.

On the other hand, the processor 63a can write data obtained during processing or data obtained as a result of processing in the data cache 63d. Moreover, the data written in this data cache 63d is written and stored in the memory section 63b after, e.g., completion of processing.

Additionally, of commands stored in the memory section 63b, a compressed or encoded command is supplied to the processor 63a through the data cache 63d. As a result, this command is decompressed or decoded, and restored to a command which can be executed by the processor 63a as it is.

Further, the command decompressed or decoded by this processor 63a is written in a special cache 63e connected with the processor 63a and subjected to processing by the processor 63a.

That is, this special cache 63e has a function as a data cache in a sense that a command compressed or decoded by the processor 63a can be written from the processor 63a, and also has a function as a command cache in a sense that the written command is read and subjected to processing by the processor 63a.

However, this special cache 63e is used only for maintenance of a command decompressed or decoded by the processor 63a, and data associated with this command, data obtained during processing or data obtained as a result of processing by the processor 63a is written in the data cache 63d.

A later-described judgment section 63f provided in the processor 63a determines either the special cache 63e or the data cache 63d in which information (command or data) from the processor 63a is to be written.

Furthermore, a backup memory 63g is connected with the special cache 63e. Moreover, a command which has been already written in the special cache 63e is transferred to the backup memory 63g when a command decompressed or decoded by the processor 63a is newly written in the special cache 63e.

This backup memory 63g may be prepared as an IC different from the memory section 63b or may be prepared as a memory space discriminated from a regular memory region in the memory section 63b by system software. In any case, the backup memory 63g must be independent from a regular memory space.

It is to be noted that the backup memory 63g does not have to be disposed. In this case, a command which has been already written in the special cache 63e is overwritten and erased when a command decompressed or decoded by the processor 63a is newly written in the special cache 63e.

FIG. 4 shows an address map of the memory cache 63c, the data cache 63d and the special cache 63e. That is, memory spaces of address 0 to address C are prepared with respect to the command cache 63c, the data cache 63d and the special cache 63e. These memory spaces correspond to the memory space of the memory section 63b.

The command cache 63c and the data cache 63d correspond to a regular memory space A which is not smaller than the address 0 and is less than the address A and a regular memory space C which is not smaller than the address B and not greater than the address C. That is, the processor 63a accesses the regular memory spaces A and C through the command cache 63c or the data cache 63d.

Additionally, the special cache 63e corresponds to a specially assigned memory space B which is not smaller than the address A and is less than the address B. That is, the processor 63a accesses the special cache 63e when an access to the specially assigned memory space B is requested. That is, this memory space B is a region in which a command decompressed or decoded by the processor 63a is written.

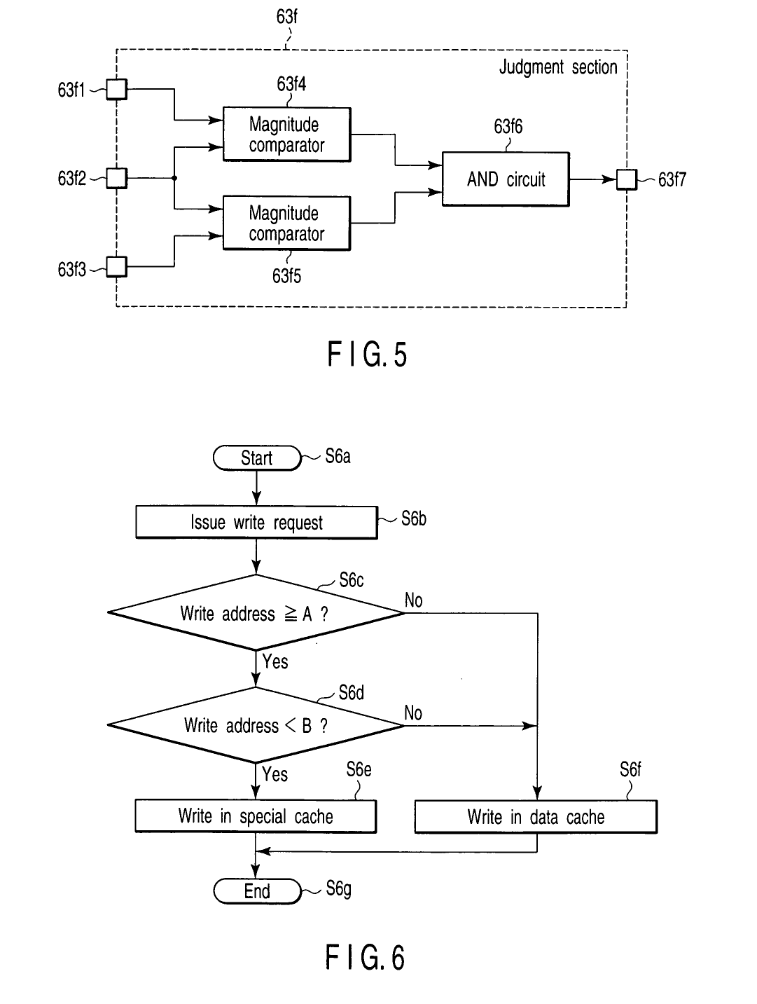

FIG. 5 shows a specific example of the judgment section 63f provided in the processor 63a. That is, the address A is input to an input terminal 63f1, a write request address is input to an input terminal 63f2, and the address B is input to an input terminal 63f3.

Further, a magnitude of the write request address input to the input terminal 63f2 is compared with a magnitude of the address A input to the input terminal 63f1 by a magnitude comparator 63f4, and also compared with a magnitude of the address B input to the input terminal 63f3 by a magnitude comparator 63f5.

Of these comparators, the magnitude comparator 63f4 outputs a logical value “1” when the write request address is not smaller than the address A, and outputs a logical value “0” in any other case. Furthermore, the magnitude comparator 63f5 outputs a logical value “1” when the write request address is less than the address B, and outputs a logical value “0” in any other case.

Moreover, an output from each of the magnitude comparators 63f4 and 63f5 is supplied to an AND circuit 63f6 where this output is subjected to an AND operation, and output from an output terminal 63f7. In this case, an output from the AND circuit 63f6 becomes a logical value “1” when both outputs from the magnitude comparators 63f4 and 63f5 are the logical value “1”, and becomes a logical value “0” in any other case.

That is, an output from the judgment section 63f becomes the logical value “1” only when the write address is not smaller than the address A and is less than the address B, and becomes the logical value “0” in any other case. Therefore, the processor 63a is controlled to perform writing in the special cache 63e when an output from the judgment section 63f is the logical value “1”, and controlled to perform writing in the data cache 63d when an output from the judgment section 63f is the logical value “0”.

FIG. 6 shows a flowchart in which processing operations of the judgment section 63f are summed up. That is, processing is started (block S6a) and, when a write request is generated at block S6b, the judgment section 63f judges whether a write address is not smaller than the address A at block S6c.

Additionally, if it is determined that the write address is not smaller than the address A (YES), the judgment section 63f judges whether the write address is less than the address B at block S6d. Here, if it is determined that the write address is less than the address B (YES), the judgment section 63f determines to perform writing in the special cache 63e at block S6e and terminates processing (block S6g).

Further, if it is determined that the write address is less than the address A at block S6c (NO), or if it is determined that the write address is not less than the address B at block S6d (NO), the judgment section 63f determines to perform writing in the data cache 63d at block S6f and terminates processing (block S6g).

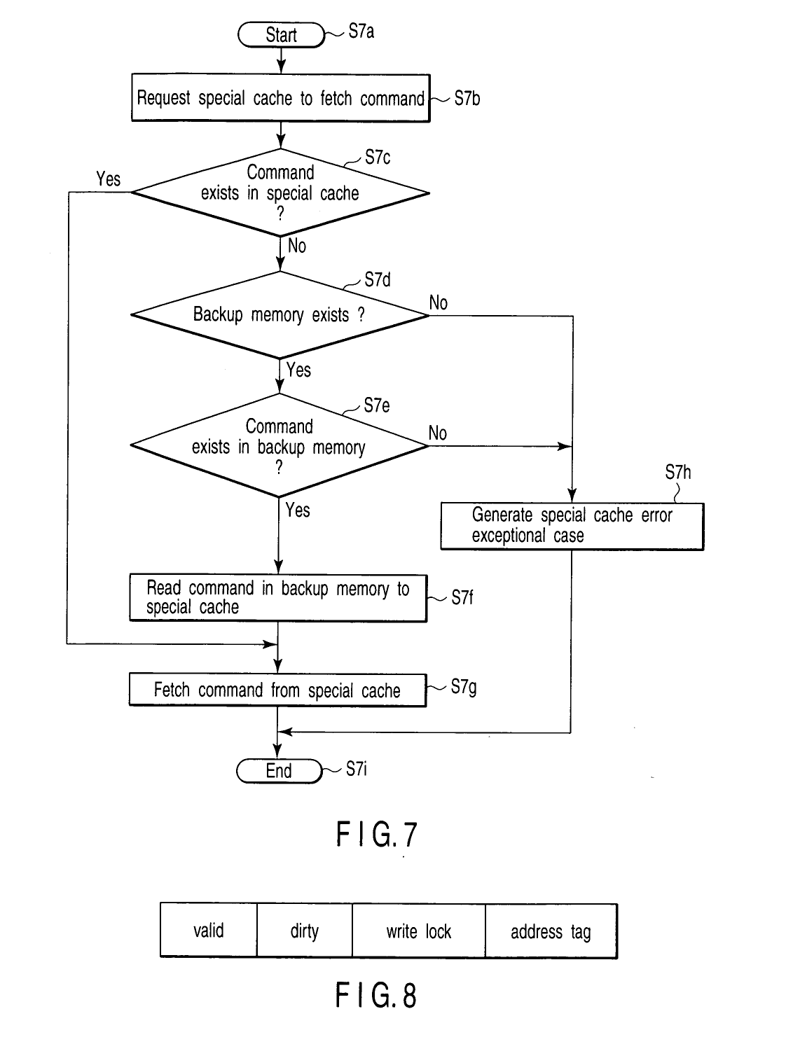

FIG. 7 shows a flowchart in which processing operations of fetching a stored command from the special cache 63e by the processor 63a are summed up. That is, when processing is started (block S7a), the processor 63a accesses the special cache 63e to request fetching of a command at block S7b.

Furthermore, the processor 63a judges whether a command exits in the special cache 63e at block S7c. If it is determined that this command exists (YES), the processor 63a fetches the command from the special cache 63e at block S7g and terminates processing (block S7i).

Moreover, if it is determined that the command does not exist in the special cache 63e at block 7c (NO), the processor 63a judges whether the backup memory 63g exits at block S7d.

Additionally, if it is determined that the backup memory 63g exists (YES), the processor 63a judges whether the command exists in the backup memory 63g at block S7e. If it is determined that this command exits (YES), the processor 63a reads the command stored in the backup memory 63g into the special cache 63e at block S7f, fetches the command from the special cache 63e at block S7g, and terminates processing (block S7i).

Further, if it is determined that the backup memory 63g does not exits at block S7d (NO), or if it is determined that the command does not exit in the backup memory 63g at block S7e (NO), the processor 63a generates a special cache error exceptional case at block S7h, calls a routine of decompression processing or decoding processing and terminates processing (block S7i).

It is to be noted that decompression processing or decoding processing of a line which will be accessed soon besides the line in which an error has occurred is also executed in this routine of decompression processing or decoding processing.

FIG. 8 shows an example of cache tags when the special cache 63e is newly provided. That is, the cache has a valid bit, a dirty bit and an address tag which are prepared in a regular cache as well as a write lock bit indicating that data is being written in the special cache 63e.

That is, in this embodiment, when writing a command in the special cache 63e, overwriting is possible without judging whether the same command has been already written in the special cache 63e. That is, the command which has been already written in the special cache 63e can be rewritten in the special cache 63e by acquiring the command from the memory section 63b and executing decompression processing or decoding processing even if this command is erased by being transferred to the backup memory at the time of overwriting or by being overwritten.

Meanwhile, in order to assure newly overwriting a command without judging whether the same command has been already written in the special cache 63e, reading must be prohibited with respect to the cache line until all the lines are updated at the time of writing.

Thus, when the write lock bit is set before performing writing in the cache line and a read request is issued during writing, a notice indicating that correct information cannot be read can be given. Further, after writing all commands in the lines, a notice indicating that correct information can be read can be given by resetting the write lock bit.

It is to be noted that the write lock bit is not necessary when a size of the cache line is one byte or the cache line can be updated in one cycle.

According to the foregoing embodiment, since a command decompressed or decoded by the processor 63a is written in the special cache 63e and subjected to processing by the processor 63a, an increase in speed of processing can be facilitated as compared with a technique which stores a command in the command cache 63c.

Furthermore, a command which is not compressed or encoded and can be executed by the processor 63a as it stands is written in the command cache 63c, and a command compressed or decoded by the processor 63a is written in the special cache 63e. Therefore, the decompressed or decoded command necessarily exists in the special cache 63e, thereby facilitating an increase in speed of processing.

Moreover, since a compressed or encoded command is written in the data cache 63d and a decompressed or decoded command is written in the special cache 63e, these commands are not replaced with each other.

Additionally, since a decompressed or decoded command can be newly overwritten without judging whether the same command has been already written in the special cache 63e, a cache error penalty can be reduced, thus facilitating high-speed processing.

Further, the processor 63a, the command cache 63c, the data cache 63d and the special cache 63e are usually constituted as one LSI. Therefore, a decompressed or decoded command cannot be output to the outside, thereby enhancing confidentiality.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A command processing apparatus comprising:
a command cache in which a command which is not compressed or encoded is written from the outside;
a data cache in which data which is input/output with respect to the outside is written and a compressed or encoded command is written from the outside;
a processor which executes processing based on a command written in the command cache, executes input/output of data with respect to the outside through the data cache, and decompresses or decodes a command written in the data cache; and
a special cache in which a command decompressed or decoded by the processor is written and which subjects the command to processing by the processor.

2. A command processing apparatus according to claim 1, wherein writing a command from the processor in the special cache is executed without judging whether the same command already exists in the special cache.

3. A command processing apparatus according to claim 1, wherein the processor comprises a judgment section which judges whether a writing target is the data cache or the special cache based on a write address.

4. A command processing apparatus according to claim 1, wherein, when a command is written in the special cache from the processor, a command which already exists in the special cache is erased.

5. A command processing apparatus according to claim 1, wherein, when a command is written in the special cache from the processor, a command which already exists in the special cache is transferred to a backup memory.

6. A command processing apparatus according to claim 1, wherein, when a requested command does not exist in the special cache, the processor judges whether a backup memory in which the command in the special cache is held exists and searches for the requested command from the backup memory if the backup memory exists.

7. An electronic device comprising:
a receiving section which receives a signal corresponding to at least one of a picture and a sound;
a processing section which executes predetermined processing to a signal received by the receiving section in order to subject the signal to at least one of picture display and sound reproduction; and
a control section which comprises: a memory which stores a command and data; a command cache in which a command which is not compressed or encoded is written from the memory; a data cache in which data which is input/output with respect to the memory is written and a compressed or encoded command is written from the memory; a processor which executes processing based on a command written in the command cache, executes input/output of data with respect to the memory through the data cache, and decompresses or decodes a command written in the data cache; and a special cache in which a command decompressed or decoded by the processor is written and which subjects the command to processing by the processor, the control section controlling the processing section to execute predetermined signal processing.

8. A command processing method comprising:
a first block of executing processing by a processor based on a command which is written in a command cache from the outside and is not compressed or encoded;
a second block of executing input/output of data with respect to the outside by the processor through a data cache in which data which is input/output with respect to the outside is written;
a third block of decompressing or decoding by the processor a compressed or encoded command written in the data cache from the outside; and
a fourth block of writing a command decompressed or decoded by the processor in a special cache and subjecting the command to processing by the processor.

9. A command processing method according to claim 8, wherein the fourth block writes a command decompressed or decoded by the processor in the special cache without judging whether the same command already exists in the special cache.

10. A command processing method according to claim 8, wherein the fourth block erases a command which already exists in the special cache when writing the command in the special cache from the processor.

11. A command processing method according to claim 8, wherein the fourth block transfers a command which already exists in the special cache to a backup memory when writing the command in the special cache from the processor.

12. A command processing method according to claim 8, further comprising:
a fifth block of judging whether a backup memory in which a command in the special cache is held exists when a command requested by the processor does not exist in the special cache, and searching for the requested command from the backup memory if the backup memory exists.
